(19) United States
(12) Patent Application Publication
(10) Pub. No.: US 2008/0034526 A1
(43) Pub. Date: Feb. 14, 2008

(54) Rubber Material

(76) Inventor: Robert Geilenkirchen, Fleron (BE)

Correspondence Address: MICHAEL BEST & FRIEDRICH LLP, 100 EAST WISCONSIN AVENUE, MILWAUKEE, WI, 53202, US

(21) Appl. No.: 10/581,846

(22) PCT Filed: Nov. 18, 2004
(86) PCT No.: PCT/DE04/02540

§ 371 Date: May 9, 2007

(30) Foreign Application Priority Data
Dec. 5, 2003 (DE) 103 56 942.1

(51) Int. Cl. B60S 1/02; C08K 3/00

(52) U.S. Cl. 15/250.001; 524/575.5

(57) ABSTRACT

A rubber material for wiper blades of windshield wipers or for motor vehicle tires, is disclosed that contains a copolymer based on isoprene and at least one other polymerizable monomer.

The invention relates to a rubber material for wiper blades for windshields or for motor vehicle tires as well as its use in accordance with the pre-characterizing clause of the independent claims.

### PRIOR ART

It is important that windshield wiper blades be as well adapted as possible to the contour of the window of a motor vehicle and that they also remain flexible at different temperatures. As a result, wiper blades are normally manufactured of elastomer profiles, wherein essentially rubber materials such as natural rubber or synthetic rubber types like chloroprene rubber or EPDM are used. In addition, wiper blades made of silicone rubber or polyurethane rubber are also known.

In addition, these types of rubber materials are also used as vibration dampers in vehicle tires. Thus, a rubber material is known from DE 42 36 218 C2 which contains a copolymer in the form of EPDM as well as, if necessary, additional rubber components such as natural rubber or a synthetic rubber like polyisoprene.

The rubber materials are subject to vulcanization during manufacturing. For this purpose, the rubber material contains a vulcanization accelerator in addition to the actual so-called vulcanization agents that produce cross-linking of the rubber material. Since the rubber material represents a mixture of several rubber components, the degree of cross-linking of the different rubber components can turn out differently as a function of their cross-linking speeds during vulcanization. The consequence of this is that loosely cross-linking rubber components are not sufficiently abrasion-resistant in a hardened state and the rubber material, e.g., in the application as a wiper rubber, tends to cause streaks to form on the surface being cleaned.

This problematic situation occurs for example in wiper rubbers containing a mixture of natural rubber and polybutadiene. In the vulcanization of a corresponding crude rubber material, an added vulcanization accelerator causes a cross-linking of the natural rubber in particular while on the other hand the polybutadiene that is also contained is only cross-linked slowly. The resulting rubber material produces an unsatisfactory wiped image because of the incompletely cross-linked polybutadiene.

The objective of the present invention is producing a rubber material which makes it possible to create abrasion-resistant profiles.

### ADVANTAGES OF THE INVENTION

The advantage the rubber material in accordance with the invention with the characterizing features of claim 1 as compared with the prior art is that a rubber material with a favorable profile of properties that is suitable for manufacturing wiper blades or vehicle tires is available, which can be manufactured in a well-reproducible and therefore cost-effective manner. This is achieved in that the rubber material is a copolymer made of isoprene and at least one additional polymerizable monomer.

The invention is based on the knowledge that natural rubber as a constituent of a crude rubber material shows relatively quick cross-linking during vulcanization while additional rubber constituents such as polybutadiene show a relatively low cross-linking speed. If the natural rubber of the crude rubber material is now replaced by the isostructural isoprene, this offers the possibility of combining quickly cross-linking isoprene units within the framework of copolymerization with loosely cross-linking butadiene units into a copolymer, which is subject to uniform cross-linking during subsequent vulcanization. In this way, the negative effects of the wiped image that would otherwise occur due to the loosely cross-linking polybutadiene are advantageously avoided.

Advantageous developments of the invention are yielded from the measures cited in the subordinate claims.

As a result, it is advantageous if the rubber material contains a mixture of furnace black and thermal black as a filler material since these are very different with respect to their granulation and the mechanical properties that result for the rubber material and therefore permit an optimal adjustment of the mechanical properties of the rubber material via the mixing ratio of the two types of carbon black.

In addition, it is advantageous if the rubber material also contains a softening agent. This makes a higher filler content of the rubber material possible without impairing its mechanical properties.

### DRAWING

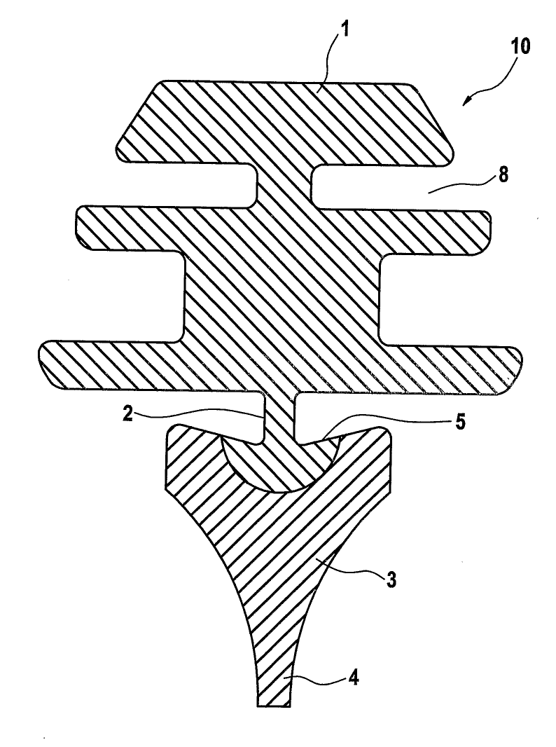

One exemplary embodiment of the invention is depicted in the drawing and described in greater detail in the following description. FIG. 1 shows a cross section through a wiper blade in accordance with the invention with an external resilient rail.

### EXEMPLARY EMBODIMENT

FIG. 1 depicts a wiper blade 10 according to a first exemplary embodiment of the present invention. The wiper blade has an essentially strip-shaped form. It is comprised of a widened top portion 1, which is connected via a flexible segment 2 with a wedge 3. The top portion 1 has recesses 8 for accommodating an external resilient rail (not shown). The wedge 3 tapers on the side towards the wiper lip 4 that is opposite from the top portion 1 and faces the glass surface being cleaned.

The head portion 1 or the flexible segment 2 is preferably manufactured of EPDM (ethylene propylene diene terpolymer), EPR (ethylene propylene copolymer), CR (chloroprene), NR (natural rubber), BR (polybutadiene), SBR (styrene butadiene rubber) or IR (polyisoprene) or mixtures of said substances. The wedge 3 and/or the wiper lip 4 are manufactured of a rubber material, which contains a copolymer based on isoprene. The copolymer can be a copolymer of isoprene and butadiene for example. However, one or more other monomers that can be copolymerized with isoprene can be used instead of butadiene. In addition, the wedge 3 or the wiper lip 4 can contain as further constituents of the rubber material, e.g., natural rubber, polybutadiene or another of the types of rubber cited as the material for the top portion 1 or the flexible segment 2. Furthermore, in order to better anchor the flexible segment 2 in the wedge 3, it is possible to manufacture a region 5 of the wedge 3 adjacent to the flexible segment 2 from the same material as the flexible segment 2. It is also possible to manufacture the wedge 3 from the rubber material of the top portion 1 or of the flexible segment 2 or from another rubber material, which differs from that of the top portion 1 or the wiper lip 4.

The material selection for the wedge 3 or the wiper lip 4 is based on the notion of combining rubber types that cross-link at a slow speed like polybutadiene and rubber types that cross-link quickly such as natural rubber with one another via copolymerization in one molecule strand so that a uniformly cross-linking rubber material is generated in the process. The constituent amounts of the monomers used for copolymerization can be adapted appropriately to the conditions required for the concrete application purpose.

Since natural rubber per se is already present as a polymer, one can fall back as a substitute on the isostructural monomer isoprene and copolymerize it with one or more monomers of another structure or composition.

The rubber material also contains a homogenizing agent if necessary, which guarantees a better intermixing of the various rubber types or fractions in the crude rubber material. At the same time, it produces a stabilization of the overall crude rubber material as a stable dispersion of filler materials and auxiliary agents in the crude rubber mass. Aromatic or aliphatic resins are used as homogenizing agents for example.

The rubber material also contains at least one filler material. The filler material is preferably formed from carbon black. So-called furnace black is used as carbon black for example. However, using a mixture of furnace black and thermal black has proven to be advantageous. While furnace black generally has a relatively fine granulation and with high filler contents produces namely an abrasion-resistant, but relative hard rubber material, thermal black has a coarse granulation, which also with high filler contents only produces a small increase in the hardness of the rubber material.

The constituent amounts of the two types of carbon black are preferably selected such that the highest possible filler content that is favorable for processing the rubber material is achieved, but on the other hand, so that the overall hardness of the hardened rubber material does not get too high since the system would otherwise be brittle and no longer capable of wiping for example.

A particularly high filler content can be achieved if a softening agent is also added to the rubber material since in this way the brittleness of the rubber material that increases with an increasing filler content can be counteracted effectively. Synthetic softening agents such as mineral oils are suitable as softening agents for example.

Normally, desiccants are added to the crude rubber material when manufacturing rubber materials. If these types of desiccants are dispensed with, the moisture contained in the base materials produces, during extrusion or vulcanization, a porous surface of the rubber profile being produced in this manner. A common desiccant that is used in rubber materials is calcium oxide for example. It forms calcium hydroxide upon contact with the moisture contained in the rubber material. However, problems can arise when calcium oxide is used, if there is crystallization of the resulting calcium hydroxide.

For this reason, the rubber material under discussion is manufactured without the addition of calcium oxide. In order to achieve a sufficiently good surface quality of the generated profile nevertheless, the moisture content of the base materials required to produce the rubber material is checked and if necessary they are stored separately under the exclusion of moisture. In addition, the vulcanization of the crude rubber material is performed with the shortest possible reaction time. A vulcanization system based on peroxides is particularly suited for this.

An example of an exemplary embodiment of a rubber material A for manufacturing a top portion 1 and a rubber material B for manufacturing a flexible segment 2, a wedge 3 or a wiper lip 4 of a wiper blade or their composition related to 100 parts by weight of elastomer (phr) is listed in the following:

| | Content in phr | Content in phr |
|---|---|---|
| Substance | Rubber Material 1 | Rubber Material 2 |
| EPDM 1 | 0.5-100 | — |
| EPDM 2 | 0.5-100 | — |
| IR BR copolymer | — | 0.5-100 |
| NR | — | 0-70 |
| BR | | 0-70 |
| Homogenizing agent | 0-10 | 0-10 |
| Furnace black | 20-120 | 5-120 |
| Thermal black | 20-120 | 0-120 |
| Peroxide | 0-10 | — |
| Sulfur | 0-1 | 0-4 |
| Accelerator | — | 0.2-10 |
| Auxiliary agent | 20-105 | 0-50 |

Manufacturing the rubber material takes place in that first one or more types of rubber are added to the extruder with the filler material(s), the homogenizing agent and additional auxiliary processing agents and undergo intensive mixing there. Alternatively, the base materials can also be added to a mixer, be mixed there and, e.g., be compression molded or be fed to a injection molding process.

A profile strand is produced in this way, wherein to produce wiper rubbers for windshield wipers said strand has the form of double strand in which two wiper rubber individual strands are connected to one another in the longitudinal direction of the double strand in region of the wiper lip. The produced double strand is fed, e.g., to a salt bad or a furnace for vulcanization and vulcanized there at a temperature of approx. 205° C. Surface modification takes place as needed in a further step, e.g., via graphitizing, halogenation, painting or coating. Afterwards, the vulcanized elastomer profile is then cut in the longitudinal direction.

As an alternative, it is possible to purposefully modify only specific surface sections of a wiper blade. Therefore, using appropriate process management with targeted covering of regions of the wiper blade that are not being modified, only the wiper lip that comes into contact with the surface being cleaned can be modified or additionally or alternatively a guide groove of the wiper blade with which the wiper blade can be inserted into a corresponding wiper blade holder.

1. Rubber material for wiper blades of windshield wipers or for motor vehicle tires, characterized in that it contains a copolymer based on isoprene and at least one further polymerizable manomer.

2. Rubber material according to claim 1, characterized in that it contains a copolymer made of isoprene and butadiene.

3. Rubber material according to claim 1, characterized in that it also contains a filler material, and that the filler material is a mixture of furnace black and thermal black.

4. Rubber material according to claim 1, characterized in that the rubber material contains 20-150 parts by weight of a filler material in relation to 100 parts by weight of elastomer.

5. Rubber material according to claim 1, characterized in that it contains a softening agent and/or mineral oil.

6. Rubber material according to claim 1, characterized in that the rubber material also contains natural rubber and/or polybutadiene.

7. Wiper blade for windshield wipers, characterized by a rubber material according to claim 1.

8. Wiper blade according to claim 7, characterized in that a segment (2), a wedge (3) and/or a wiper lip (4) of the wiper blade contain a copolymer made of isoprene and butadiene.

9. Wiper blade according to claim 6, characterized in that a top portion (1) and/or a segment (2) contain EPDM and/or CR.

10. Rubber material according to claim 7, characterized in that it contains a copolymer made of isoprene and butadiene.

11. Rubber material according to claim 7, characterized in that it also contains a filler material, and that the filler material is a mixture of furnace black and thermal black.

12. Rubber material according to claim 7, characterized in that the rubber material contains 20-150 parts by weight of a filler material in relation to 100 parts by weight of elastomer.

13. Rubber material according to claim 7, characterized in that it contains a softening agent and/or mineral oil.

14. Rubber material according to claim 7, characterized in that the rubber material also contains natural rubber and/or polybutadiene.

15. Rubber material according to claim 2, characterized in that it also contains a filler material, and that the filler material is a mixture of furnace black and thermal black.

16. Rubber material according to claim 15, characterized in that the rubber material contains 20-150 parts by weight of a filler material in relation to 100 parts by weight of elastomer.

17. Rubber material according to claim 16, characterized in that it contains a softening agent and/or mineral oil.

18. Rubber material according to claim 17, characterized in that the rubber material also contains natural rubber and/or polybutadiene.
